(19) United States
(12) Patent Application Publication
(10) Pub. No.: US 2004/0162765 A1
(43) Pub. Date: Aug. 19, 2004

(54) System and a method for locating an item offered for sale by a merchant

(76) Inventor: Hobie Reber, Overland Park, KS (US)

Correspondence Address: PATENTS+TMS, A Professional Corporation, 1914 North Milwaukee Avenue, Chicago, IL, 60647, US

(21) Appl. No.: 10/771,890

(22) Filed: Feb. 4, 2004

Related U.S. Application Data
(60) Provisional application No. 60/447,961, filed on Feb. 19, 2003.

(51) Int. Cl. G06F 17/60

(52) U.S. Cl. 705/26

(57) ABSTRACT

A system and a method searches items offered for sale by a merchant. The system and the method accesses and/or searches information relating to items and/or services offered for sale by a merchant located within a multi-dealer retail establishment. The system and the method accesses the information from any computer terminal with network accessible capabilities. Moreover, the system and the method accesses the information in the database to locate available items and/or to provide prices of the available items.

This application claims the benefit of the U.S. Provisional Application Serial No.: 60/447,961, filed on Feb. 11, 2003.

### BACKGROUND OF THE INVENTION

The present invention generally relates to a system and a method to identify available products offered for sale by a merchant. More specifically, the present invention relates to a system and a method which provides information about the products and/or the services offered for sale by a merchant located within a multi-dealer retail establishment, such as, for example, an antique mall, a flee-market, a shopping mall and/or the like. Further, the invention relates to a computer-based system and a method which may be accessed from any computer terminal which affords network accessible capabilities, such as, for example, internet, intranet and/or the like. Moreover, the invention relates to a system and a method for accessing the inventory of a merchant to locate, for example, the availability and/or a price of an item offered for sale by the merchant.

It is, of course, generally known to provide guides which present information relating to merchants, such as, for example, available goods and/or services of the merchants. Further, it is generally known to provide the guides which contain information including, for example, prices and/or photographic representations relating to available products and/or services offered for sale by the merchants.

However, the information relating to the merchants and/or the products which they offer for sale is generally presented in paper format, such as, for example, catalogs or circulars within a newspaper. Further, these guides present a selection of products and services offered for sale by a merchant and do not reflect the entire inventory available for the merchant. Still further, these guides are not generally updateable and/or do not show the complete availability of products and/or services at any specific time. Moreover, these guides do not contain inventory fluctuations resulting from completed sales of the products and/or incoming inventories of the products. Furthermore, every potential consumer does not receive a copy of the paper circular and/or catalog and/or may not be aware of the inventory of products and/or services currently available by the merchant.

Known websites which provide information relating to the merchant and/or the products and/or the services available from the merchants are not updateable and/or do not show the inventory fluctuations of available products and/or services at a specific time. Moreover, these websites may not necessarily reflect the current sale prices of products and/or services available for sale by the merchants.

A need, therefore, exists for an improved computer-based system and a method which allows merchants within a multi-dealer retail establishment to provide users with information regarding products and/or services offered for sale by the merchants.

### SUMMARY OF THE INVENTION

The present invention provides a system and a method for accessing information relating to merchants and/or products and/or services offered for sale by the merchants. More specifically, the present invention provides a system and a method for identifying items available for sale from the merchant located within a defined multi-dealer retail establishment. Further, the present invention provides a system and a method which offers information relating to the availability, the location, the condition and/or the price of items offered for sale by merchants for a user to access from a computer having network access capabilities, such as, for example, internet, intranet and/or the like.

To this end, in an embodiment, a system for determining a location of an item offered for sale by a merchant at a facility in a multi-dealer retail establishment is provided. The system has a computer network and a database associated with the computer network. Additionally, the system has a means for inputting merchant information into the database wherein the merchant information is associated with a location of the facility of the merchant in the multi-dealer retail establishment. Further, the system has a means for inputting item information in the merchant information wherein the item information is associated with the a description of the item and a price of the item. Still further, the system has a means for accessing the merchant information in the database from a computer terminal via the computer system wherein the computer terminal is remote with respect to the database. Moreover, the system has a means for determining the location of the item in the multi-dealer retail establishment by searching the item information in the database wherein the item information is associated with the location of the facility of the merchant in the multi-dealer retail establishment.

In an embodiment, the computer network is the internet.

In an embodiment, the system has a remote server wherein the database is contained on the remote server and a website providing access to the database.

In an embodiment, the system has a means for modifying the merchant information in the database.

In an embodiment, the system has a password associated with the merchant for accessing the merchant information in the database.

In an embodiment, the system has an electronic map associated with the multi-dealer retail establishment wherein the location of the facility of the merchant associated with the item information is displayed on the electronic map.

In an embodiment, the system has a means for inputting an image associated with the item into the item information in the database and a means for accessing the image associated with the item in the database from the computer terminal.

In another embodiment, a method for locating an item offered for sale by a merchant in a multi-dealer retail establishment by a user wherein the merchant has a location within the multi-dealer retail establishment is provided. The method the steps of providing a computer network and providing a database connected to the computer network wherein the database includes merchant information associated with the merchant and further wherein the merchant information includes the location of the merchant within the multi-dealer retail establishment. Further, the method has the step of inputting a product list of the merchant into the merchant information in the database wherein the product list includes item information associated the item offered for sale by the merchant. Still further, the method has the step of providing a first access to the database for viewing the merchant information of the merchant in the database via the computer network. Moreover, the method has the steps of searching the product list in the merchant information based on the item information associated with the item and determining the location of the merchant in the multi-dealer retail establishment based on the merchant information associated with the item information in the product list.

In an embodiment, the computer network is the internet.

In an embodiment, the first access to the database is wireless.

In an embodiment, the method has the steps of providing a remote server and storing the database on the remote server.

In an embodiment, the method has the step of providing a second access to the database for modifying the merchant information in the database via the computer network.

In an embodiment, the first access is from a remote computer terminal with respect to the database.

In an embodiment, the method has the step of providing a password for accessing the merchant information in the database via the computer system.

In an embodiment, the first access to the database is a computer website on the computer network wherein the computer website is remote with respect to the database.

In an embodiment, the method has the step of displaying the location of the merchant in the multi-dealer retail establishment on a map wherein the map is associated with the multi-dealer retail establishment.

In an embodiment, the method has the step of downloading an image into the item information of the item in the database via the computer network wherein the image is associated with the item.

In an embodiment, the item information includes geographical information associated with the item for sale by the merchant.

In an embodiment, the method has the steps of inputting user information into the database via the computer system wherein the user information is associated with the user and searching the product list in the merchant information base on the user information.

In an embodiment, the method has the step of inputting an inventory of the merchant into the database via the computer system wherein the inventory is associated with the product list of the merchant and further wherein the inventory includes the item for sale and modifying the inventory of the merchant via the computer system.

It is, therefore, an advantage of the present invention to provide a system and a method which generates and/or maintains a database for storing information relating to merchants within a multi-dealer retail establishment.

Another advantage of the present invention is to provide a system and a method which allows the database to be searchable from a local terminal and/or from a remote terminal location.

A further advantage of the present invention is to provide a system and a method for updating the database and/or storing information relating to available products and/or services from merchants within the multi-dealer retail establishment.

A still further advantage of the present invention is to provide a system and a method for accessing the merchants and/or the products offered for sale by the merchants which allow a user to search the database for merchants based on the characteristics associated with the merchants.

Yet another advantage of the present invention is to provide a system and a method for accessing the merchants and/or products offered for sale by the merchants which allow the user to search the database for merchants based on the characteristics associated with the products offered for sale by the merchants.

Still further, an advantage of the present invention is to provide a system and a method which allows remote accessing of the information within the database to effectively increase business conducted by the merchants in the multi-dealer retail establishment.

Another advantage of the present invention is to provide a system and a method which facilitates and/or expedites the shopping experience of the user with the merchants in the multi-dealer retail establishment.

And, another advantage of the present invention is to provide a system and a method which provides an additional source of income to the multi-dealer retail establishment by charging the merchants a fee to list products offered for sale by the merchants within the database.

A further advantage of the present invention is to provide a system and a method which may offer a complete and/or accurate listing of available products for sale by the merchants to the user.

Another advantage of the present invention is to provide a system and a method which facilitates bookkeeping for merchants by maintaining a complete and/or accurate inventory of products available for sale by the merchants.

Yet another advantage of the present invention is to provide a system and a method which encourages users to return to the multi-dealer retail establishment to conduct business with the merchants based on the ease of locating available products at the multi-dealer retail establishment.

Still further, an advantage of the present invention is to provide a system and a method to allow marketing to users based on obtained demographic information and/or preference information.

Another advantage of the present invention is to provide a system and a method which allows a user to create a wish-list of items and/or receive notice after an item of the wish-list is available.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of an embodiment of the present invention.

FIG. 2 illustrates a flowchart of an embodiment of the present invention.

FIG. 3 illustrates a flowchart of an embodiment of the present invention.

FIG. 4 illustrates a flowchart of an embodiment of the present invention.

### DETAILED DRESCRIPTION OF THE PRESENTLY PREFERRED EMBODIMENTS

The present invention generally relates to a system and a method for searching items offered for sale by a merchant. More specifically, the present invention relates to a system and a method for providing and/or searching information relating to items and/or services offered for sale by a merchant located within a multi-dealer retail establishment. Further, the invention relates to a system and method which may be accessed from a computer terminal with network access capabilities, such as, for example, internet, intranet and/or the like. Moreover, the invention relates to a system and a method for accessing a database which contains the information relating to the inventories of merchants to locate, for example, the availability of and/or price of an item offered for sale by the merchant.

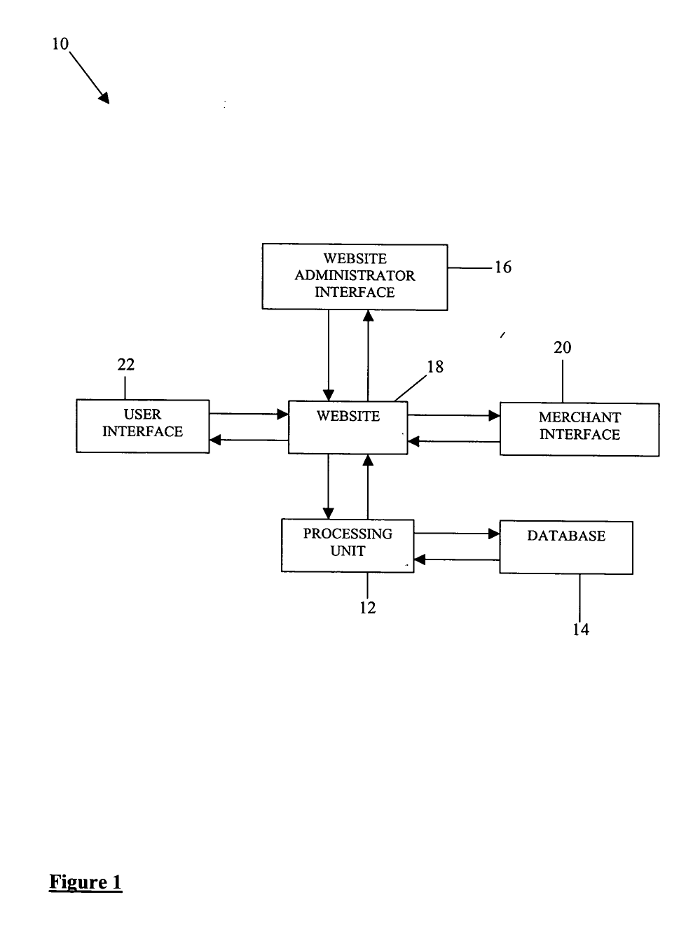

Referring now to the drawings, FIG. 1 illustrates the system 10 for locating an item offered for sale by a merchant at a multi-dealer retail establishment which has a website 18 maintained by a processing unit 12. The website 18 may contain several windows and/or search fields which may guide the user in locating, for example, merchants, items offered for sale by the merchants, and/or multi-dealer retail establishments, such as, for example, shopping centers, antique mall, flee-markets, consumer malls and/or the like.

The website 18 may include a merchant interface 20 which may allow a merchant to access the website 18 and/or to enter information on the website 18. The information entered by the merchant may be merchant information, such as, for example, a merchant number and/or item information, such as, for example, a description of the item, a price of the item and/or a picture of the item being offered for sale by the merchant. Further, the merchant interface 20 may also automatically connect to the website 18. The processing unit 12 may be connected to a database 14. Still further, the information entered into the merchant interface 20 by the merchant may be stored in the database 14 via the processing unit 12. The merchant interface 20 may include a real-time web camera located on the premises of the merchant. The real-time web camera may be positioned within the premises of the merchant to allow viewing of the items offered for sale. Moreover, the information in the database 14 may be updated and/or stored in the database 14 when, for example, a new shipment to the merchant arrives and/or when a sale of an item is completed.

The system 10 may also include a user interface 22 which may allows a user to access and/or utilize the website 18 and/or the database 14. The user may create and/or store a user profile in the database 14. Further, the user profile may contain user information, such as, for example, the artistic tastes, personal interests and/or item preferences. Still further, the user may search the database 14 contained in the processing unit 12 in respect to the user information stored in the database 14. These item preferences may be determined with an algorithm which analyzes the responses of the user to a series of questions contained in a survey. The user profile may contain one or more parameters for a searching the database 14. The parameters may include information relating to, for example, a state, a city, a shopping center, a merchant, and/or items which the user may have an interest in based on the user profile.

The database 14 may contain information relating to merchants, items offered for sale by the merchants, multi-dealer retail establishments, physical locations of multi-dealer retail establishments, physical locations of the merchants located within the multi-dealer retail establishments and/or the like. Further, the information relating to the items found in the database 14 may be arranged by category. The user interface 22 may allow the user to select and/or store one or more categories, such as, for example, favorites, interests and/or the like. The categories may relate to, for example, the merchants, the items offered for sale by the merchants, the multi-dealer retail establishments, the physical locations of the multi-dealer retail establishments, the physical locations of the merchants located within the multi-dealer retail establishments, the state, the city, the merchant information, the item information and/or the like. Moreover, the processing unit 12 may search the database 14 according to the category selections stored in the user profile. Alternatively, the user may conduct a manual search of the database 14 wherein the user may specify the parameters of the search. The parameters of the manual search may relate to, for example, the city, the multi-dealer retail establishments, the merchants, and/or the items offered for sale by the merchants. The results of a search may be stored within the database 14.

The website 18 may include a website administrator interface 16. The website administrator interface 16 may allow a website administrator of the website 18 to access and/or update the website 18, the processing unit 12 and/or the database 14. Further, the website administrator interface 16 may allow the administrator to debug the computer program on which the website 18 is based and/or manage authorizations of the users and/or the merchants with respect to the website 18, the processing unit 12 and/or the database 14. Moreover, the website administrator interface 16 may provide the website administrator with access to system 10 for any other reason which may be apparent to one of ordinary skill in the art.

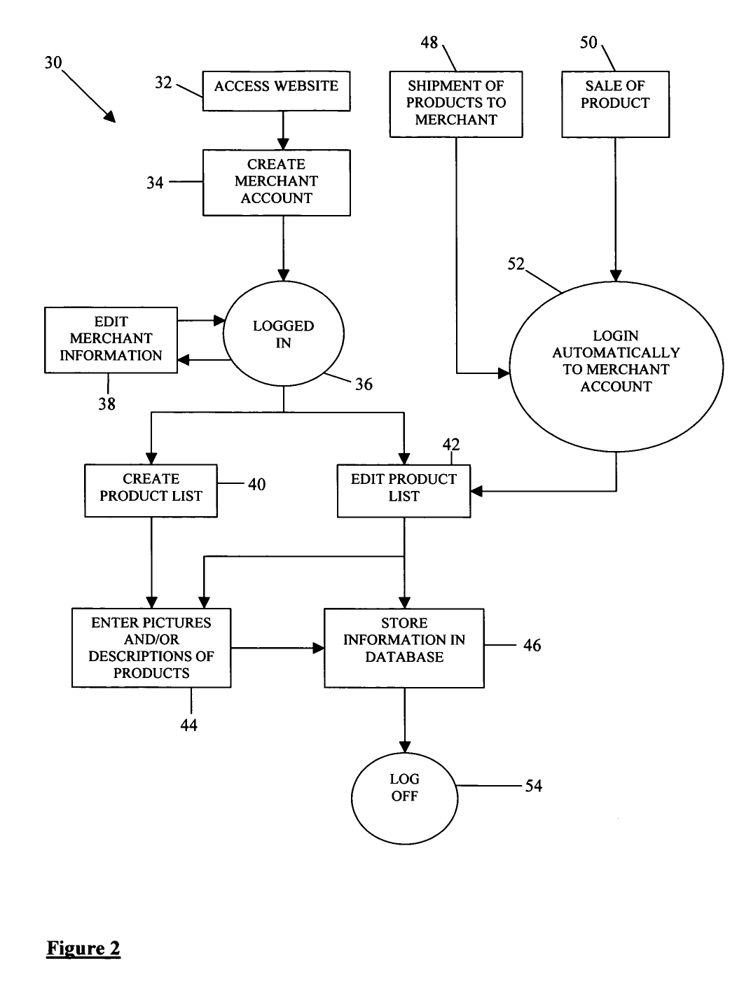

FIG. 2 illustrates a flowchart 30 of a method for a merchant to create a merchant account by accessing the website 18 and/or to input merchant information relating to the merchant therein via the merchant interface 20. Via step 32, the merchant may access the website 18 from a computer terminal, such as, for example, a laptop computer, a personal digital assistant, a cellular telephone and/or the like. The computer terminal may have network accessible capabilities, such as, for example, internet, intranet and/or the like. Further, the merchant may access the website 18 by directing the network browser of the computer terminal to a URL address associated with the website 18. A merchant accessing the website 18 for the first time may be required to pay a listing fee to initially gain access to the website 18. Upon payment of the listing fee by the merchant, the merchant may be permitted to access the website 18, to enter the merchant information on the website 18 and/or to store the merchant information in the database 14 of the website 18. The merchant may pay the listing fee, for example, directly through the website 18 via an electronic payment method and/or the like. The present invention should not be deemed as limited to the embodiments of a specific computer terminal having specific network accessible capabilities and/or a specific payment method for the listing fee by the merchant.

Upon accessing the website 18, the merchant may proceed to create a merchant account via step 34. Alternatively, the merchant may not be permitted to create the merchant account until the listing fee is paid. The merchant account may be created with merchant information input into the website 18 via the computer terminal by the merchant. Further, the merchant account may contain merchant information, such as, for example, a location of the merchant within a multi-dealer retail establishment, additional locations of the merchant, business hours of the merchant at all locations, contact information of the merchant at all locations, electronic mail addresses of the merchant and/or the like. The merchant may be permitted to store the merchant information in the database 14 of the system 10 via step 46. It should be understood that the merchant information may contain any information relating to the merchant that may be apparent to those skilled in the art.

The merchant may be granted a merchant number and/or a merchant password from the website administrator after the merchant account has been created. The merchant number and/or merchant password may allow the merchant to access the website 18 via the merchant interface 20 from computer terminal and/or to update and/or to store the merchant information contained within the database 14 of the website 18 via step 46. Further, the merchant may access the merchant account by logging into the website 18 and/or entering the password granted to the merchant into the website 18 via step 36. After successfully logging into the merchant account, the merchant may edit, create and/or store merchant information regarding the merchant profile on the website 18 via step 38. Still further, the merchant may submit any merchant information contained within the merchant profile directly to the website administrator via a communication method, such as, for example, an email and/or the like. Moreover, the present invention should not be deemed as limited to the embodiment of a specific communication method for contacting the website administrator.

The merchant may create a product list on the database 18 via step 40 and/or store the product list in the database 14 via step 46. The merchant may use the computer terminal to enter item information into the product list via step 44. The product list may contain item information such as a name of the item, number of the item, a category listing which relates to the item, an available quantity of the item, a location of the item, a price of the item and/or the like. Further, the merchant may download a digital image of the item into the item information of the product list. The digital image may be contained in an electronic file having a computer format, such as, for example, JPEG, TIFF, JFIF, Bitmap and/or the like. The product list may permit the merchant to enter item information for one or more items offered for sale by the merchant via step 44. Still further, the listing fee charged to the merchant may be based upon the number of items contained within the product list of the merchant. For example, the listing fee for one to fifty items may be ten dollars per month or may be fifteen dollars per month for fifty-one to one hundred items and/or may be twenty dollars per month for an unlimited amount of items. The multi-dealer retail establishment may charge a regular subscription rate to the merchant which may provide the multi-dealer retail establishment with an additional source of revenue. It should be understood that the item information may contain any information relating to the item that may be apparent to those skilled in the art. Moreover, the present invention should not be deemed as limited to the embodiment of a specific computer format of the electronic file.

A merchant which has previously created a product list may log into the merchant account from the merchant interface 20 via step 36 and/or edit the product list via step 42. Further, the merchant may remove and/or add an item and/or item information relating to an item via step 42. Still further, the merchant may store the product list in the database 14 of the website 18 via step 46. Moreover, the merchant may log off of the database 18 and/or exit the system 10 via step 54.

If the merchant receives a shipment of products via step 48, the merchant may have a computer system with accounting software which may automatically login to the merchant account via step 52. Further, the shipment of products may have packaging with electronic codes which identify the contents of the shipment of products. The computer system of the merchant may have a scanning device which may read the electronic codes relating to the shipment of products and/or identify the items within the shipment of products based on the electronic codes of the shipment of products.

The accounting software utilized by the merchant may access the product list within the merchant account via the merchant interface 20. Further, the accounting software utilized by the merchant may automatically add the items received within the shipment to the product list via step 42. Alternatively, if a sale of a product is completed via step 50, the accounting software may identify the item sold by the merchant based on the electronic code associated with the item. Still further, the accounting software may login automatically to the merchant account via step 52. The accounting software may access the product list and/or the item information of the merchant account via step 42 and/or may update the item information including the quantity of the item via step 44. The accounting software may automatically decrease the quantity of the item to reflect the quantity of the items sold by the merchant and/or may delete the item from the product list if the entire inventory of the item has been sold by the merchant. The website 18 may store the product list in the database 14 via step 46 and/or the merchant may log off of the website and/or exit the system 10 via step 54.

The product list may be edited manually by the merchant and/or automatically by the accounting software utilized by the merchant. Further, the product list of the merchant may represent an accurate inventory list of the items offered for sale by the merchant. Moreover, the merchant information and/or the product list of the merchant stored in the database 14 may be accessible to the users and/or the website administrator of the system 10 via the website 18 and the user interface 22 and the website administrator interface 16, respectively.

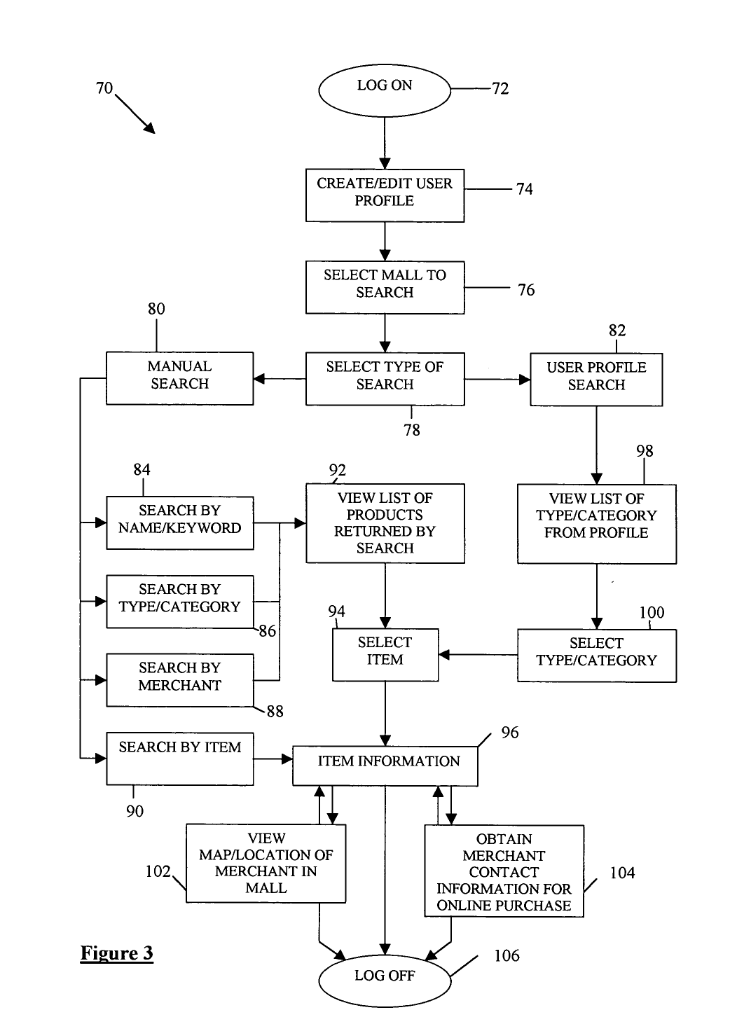

FIG. 3 illustrates a flowchart 70 in an embodiment of a method for a user to search the product lists of merchants and/or item information in the database 14 of the system 10. The user may access the website 18 of system 10 from the computer terminal having the network assessable capabilities with the user interface 22 and/or may log on to the website 18 via step 72. A user accessing the website 18 for the first time may create a user profile via step 74. Further, a user which has previously created a user profile may access the website 18 and/or edit the user profile via step 74. After creating the user profile via step 74, the user may be provided with a username and/or user password from the website administrator. Still further, the user may enter the username and/or user password into the website 18 to log into the system 10 via step 72 and/or access the user profile via step 74. The user may enter user information into the user profile from the computer terminal via step 74. The user information may included, for example, a name of the user, an address of the user, an electronic mail address of the user, a wish-list which includes items in which the user is seeking to purchase, other contact information and/or the like. Moreover, the user information may be used in marketing directed towards the user from, for example, the merchant, an owner of the multi-dealer retail establishment, the website administrator and/or the like. It should be understood that the user information may contain any information relating to the user that may be apparent to those skilled in the art.

Alternatively, the user may search the database 14 without creating a user profile and/or accessing a user profile. Further, the user may search the database 14 by, for example, entering the name of the item and/or the merchant information on the website 18. The website 18 may display item information for an item in the database 14 which matches the name of the item entered on the website 18 by the user. Still further, the website 18 may display a product list of a merchant and/or merchant information in the database 14 which matches the merchant information entered on the website 18 by the user.

After successfully logging into the website 18 of the system 10, the user may then proceed to search the malls included within the system 10 and/or select one or more of the malls via step 76. The malls may be listed in the database 14 according to, for example, a location of the mall, hours of operation of the mall and/or the like. It should be understood that the malls may be any multi-dealer retail establishment that may be apparent to those skilled in the art. Further, the present invention should not be deemed as limited to the embodiment of a specific mall and/or multi-dealer retail establishment. Moreover, it should be understood that the malls may be listed according to any information relating to the malls and/or items available for sale at the malls that may be apparent to those skilled in the art.

Via step 78, the user may select a type of search to be conducted within the database 14 which may be associated with the selected mall of step 76. The system 10 provides a manual search of the item and/or the information within database 14 via step 80 or a user profile search of the item and/or the information within the database 14 via step 82. Further, the manual search may include a search of the merchant profile and/or the product list by, for example, the name of the merchant and/or a keyword related to the merchant via step 84, a type and/or category relating to the items via step 86, a name of the merchant via step 88 and/or an item indicator associated with the item via step 90. The item indicator may a sequence of computer characters assigned to represent the item information of the item by the website administrator. The website may provide a pull-down list of the categories to select. The website may allow the user to manually enter the category of step 86 and/or the name of the merchant of step 88. Further, the user may select any previous manual searches conducted by the user. The user may create a list of favorite merchants which may be stored in the user profile and may be utilized to search the database 14. Still further, the user may create a list of items in which the user is looking to purchase, such as, for example, a wish-list of items. An electronic notice may be generated in the database 14 when an item in the wish-list of the user becomes available. Moreover, the electronic notice may be stored in the user profile and may be displayed to the user on the website 18.

A list of products in the database 14 which match the manually search criteria may be displayed by the website 18 on the computer terminal via step 92. The list of product may contain all items with entries which match the manual search. The user may select an item within the list of products via step 94 and/or may view the item information for the item selected within the list of products via step 96. Alternatively, the user may manually search the database 14 by item indicator via step 90 and/or may view the item information for the item returned from the search via step 96.

If the user chooses to search via the user profile search of step 82, the user will view a list of categories and/or types of items offered for sale at the selected mall of step 76 via step 98. Further, the user may then select a type or category of items to be search in the database 14 via step 100. The user may then select an item from a returned list of products containing items which match the selected category and/or type of step 100 via step 94. Moreover, the user may view the item information in the database 14 for the selected item of step 94 on the computer terminal via step 96.

The database 14 may store maps relating to the multi-dealer retail establishments of the system 10. The maps may represent the physical layout of the establishments and the locations of the merchants at the establishments. The user may access the map in database 14 and/or view the location of the item and/or the merchant offering the selected item of step 94 for sale via step 102. Moreover, the user may obtain directions and/or driving directions from the location of the user to the location of the merchant offering the selected item for sale via step 102.

The merchant profile may contain merchant contact information for the merchant, such as, for example, an electronic mail address for the merchant and/or the like. Via step 104, the user may access the merchant contact information and contact the merchant to, for example, obtain additional information regarding the selected item of step 94, place a hold on the selected item of step 94, and/or conduct an online purchase of the selected item of step 94. Further, the user may conduct an on-line purchase of the item directly from the website 18 via step 104. Still further, the on-line purchase may be conducted via an electronic transaction which utilizes a financial account, such as, for example, a bank account, a credit card account, a money market account and/or the like. It should be understood that the on-line purchase of the item may be conducted by any electronic transaction that may be apparent to those skilled in the art. Moreover, the user may then log off the website 18 and/or exit the system 10 via step 106.

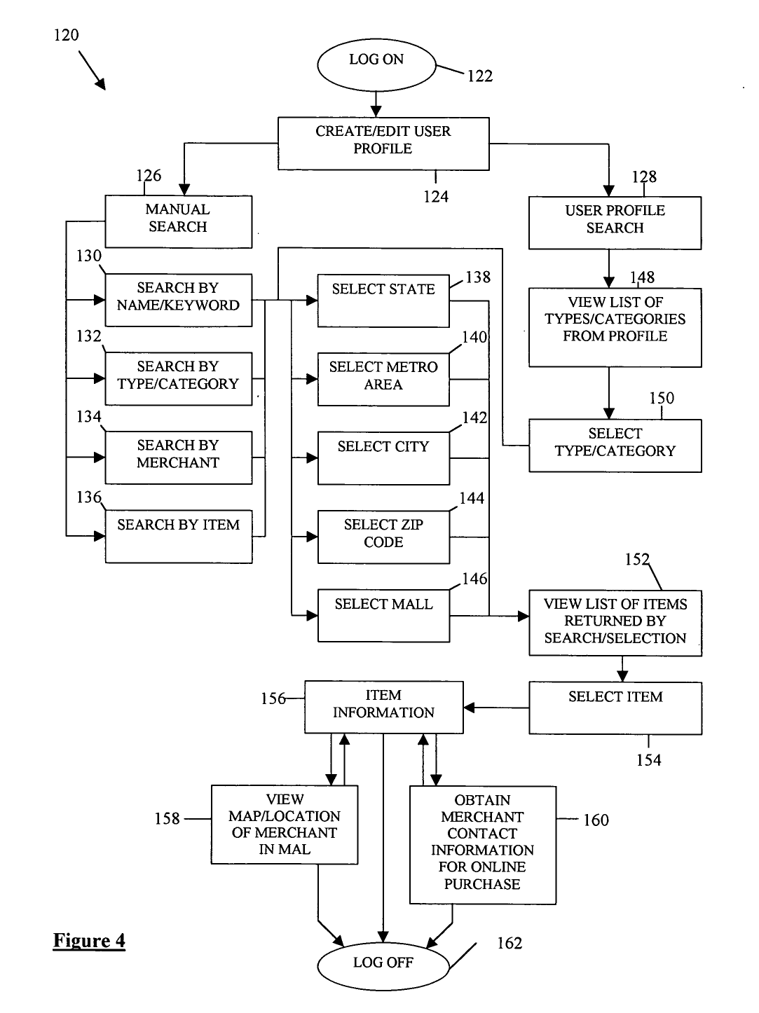

FIG. 4 illustrates a flowchart 120 in another embodiment of a method for a user to search the product lists of merchants and/or item information stored in database 14 of the system 10. The user may access the website 18 of system 10 with the computer terminal via the user interface 22. The user may log onto the website 18 with the computer terminal via step 122. The user profile may contain user information, such as, locational information of the user, locations of the multi-dealer retail establishments, merchants which the user has previously purchased items, addresses of the user, contact information, shipping addresses of the user, payment information of the user, past purchase information of the user, clothing size information of the user, likes and/or dislikes of the user and/or the like. Additionally, the user profile may contain user information relating to prior searches by the user, such as, for example, purchases by the user and/or the like. The user information and/or the user profile may be stored on the database 14 of website 18 via step 124. Moreover, it should be understood that the user information may be any information relating to the user of system 10 that may be apparent to those skilled in the art.

The user may search merchant profiles and/or the product lists in the database 14 of system 10 with a manual search via step 126 or a user profile search via step 128. The manual search may provide a search by, for example, a name and/or a keyword relating to the item via step 130, a type and/or a category relating to the item via step 132, a name and/or number of the merchant via step 134 and/or an item via step 136 and/or the like. The website 18 may provide a pull-down list containing, for example, categories for step 132, names of merchants for step 134 and/or the items for step 136. The user may scroll down the pull-down lists and may make selections from the pull-down lists to conduct the manual search. Moreover, the user may select a name and/or a keyword from prior searches to conduct the manual search via step 130.

Alternatively, the user may select the user profile search via step 128. The user profile search may contain the pull-down lists relating to the types and/or categories of the item and may be view by the user via step 148. Further, the pull-down list of the types and/or the categories of the item offered by merchants may be based on the user information within the user profile. The user may select the type and/or the category of the item to be searched via step 150.

Additionally search criteria may be added to the manual searching or the user profile searching to further limit the search. In either case, the user may enter additional search limitations, such as, for example, a State within the United States of America (hereinafter “a State”) via step 138, and/or a metropolitan area within a State via step 140, and/or city within a State via step 142, and/or zip code within the United States of America via step 144 and/or a specific mall via step 146. The profile information with a user profile stored on the database 14 may be automatically transferred into the additional search limitations for a user conducting a user profile search via step 128. If the user is conducting a manual search via step 126, the user may be provided with pull-down lists for additional search limitations.

The user may then view a list of products in the database 14 on the computer terminal returned by the website via step 152. The list of products may contain items which match some or all of the search limitations specified in the manual search or the user profile search. The user may select an item from the list of products via step 154 and/or view the item information relating to the selected item via step 156. Further, the user may view the digital image of the selected item and/or operate the web camera to view the selected item. Moreover, the user may then log off the website 18 and/or exit the system 10 via step 162.

The user may access the map in database 14 and/or view the location of the selected item and/or the merchant offering the selected item of step 154 for sale via step 158. Additionally, the user may obtain driving directions from the location of the user to the location of the merchant offering the selected item for sale via step 158. Moreover, the user may then log off the website 18 and/or exit the system 10 via step 162.

The merchant profile in the database 14 may contain the merchant contact information for the merchant. Per step 160, the user may access the merchant contact information and contact the merchant to, for example, obtain additional information regarding the selected item of step 154, place a hold on the selected item of step 154, and/or conduct an online purchase of the selected item of step 154. Further, the user may conduct the on-line purchase of the selected item directly from the website 18 via step 160. Moreover, the user may then log off the website 18 and/or exit the system 10 via step 162.

The users may search and/or access the merchant profiles and/or the products lists in the database 14 of the system 10 via a computer terminal connected with a user interface 22. The users may search the products lists of merchants at the multi-dealer retail establishments to find the location of items in which the users seek to purchase. Further, the database 14 may permit the merchants to store and/or update item information within the merchant profiles which may relate to the available items offered for sale by the merchants. Still further, the merchant may access the system via the merchant interface 20. The system 10 may allow the users to quickly locate items to be purchase and/or visit the location of the merchant wherein the items may be viewed.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for determining a location of an item offered for sale by a merchant at a facility in a multi-dealer retail establishment, the system comprising:
a computer network;
a database associated with the computer network;
means for inputting merchant information into the database wherein the merchant information is associated with a location of the facility of the merchant in the multi-dealer retail establishment;
means for inputting item information in the merchant information wherein the item information is associated with the a description of the item and a price of the item;
means for accessing the merchant information in the database from a computer terminal via the computer system wherein the computer terminal is remote with respect to the database; and
means for determining the location of the item in the multi-dealer retail establishment by searching the item information in the database wherein the item information is associated with the location of the facility of the merchant in the multi-dealer retail establishment.

2. The system of claim 1 wherein the computer network is the internet.

3. The system of claim 1 further comprising:
a remote server wherein the database is contained on the remote server; and
a website providing access to the database.

4. The system of claim 1 further comprising:
means for modifying the merchant information in the database.

5. The system of claim 1 further comprising:
a password associated with the merchant for accessing the merchant information in the database.

6. The system of claim 1 further comprising:
an electronic map associated with the multi-dealer retail establishment wherein the location of the facility of the merchant associated with the item information is displayed on the electronic map.

7. The system of claim 1 further comprising:
means for inputting an image associated with the item into the item information in the database; and
means for accessing the image associated with the item in the database from the computer terminal.

8. A method for locating an item offered for sale by a merchant in a multi-dealer retail establishment by a user wherein the merchant has a location within the multi-dealer retail establishment, the method comprising the steps of:
providing a computer network;
providing a database connected to the computer network wherein the database includes merchant information associated with the merchant and further wherein the merchant information includes the location of the merchant within the multi-dealer retail establishment;
inputting a product list of the merchant into the merchant information in the database wherein the product list includes item information associated the item offered for sale by the merchant;
providing a first access to the database for viewing the merchant information of the merchant in the database via the computer network;
searching the product list in the merchant information based on the item information associated with the item; and
determining the location of the merchant in the multi-dealer retail establishment based on the merchant information associated with the item information in the product list.

9. The method of claim 8 wherein the computer network is the internet.

10. The method of claim 8 wherein the first access to the database is wireless.

11. The method of claim 8 further comprising the steps of:
providing a remote server; and
storing the database on the remote server.

12. The method of claim 8 further comprising the step:
providing a second access to the database for modifying the merchant information in the database via the computer network.

13. The method of claim 8 wherein the first access is from a remote computer terminal with respect to the database.

14. The method of claim 8 further comprising the step of:
providing a password for accessing the merchant information in the database via the computer system.

15. The method of claim 8 wherein the first access to the database is a computer website on the computer network wherein the computer website is remote with respect to the database.

16. The method of claim 8 further comprising the step of:
displaying the location of the merchant in the multi-dealer retail establishment on a map wherein the map is associated with the multi-dealer retail establishment.

17. The method of claim 8 further comprising the step of:
downloading an image into the item information of the item in the database via the computer network wherein the image is associated with the item.

18. The method of claim 8 wherein the item information includes geographical information associated with the item for sale by the merchant.

19. The method of claim 8 further comprising the steps of:
inputting user information into the database via the computer system wherein the user information is associated with the user; and
searching the product list in the merchant information base on the user information.

20. The method of claim 8 further comprising the steps of:
inputting an inventory of the merchant into the database via the computer system wherein the inventory is associated with the product list of the merchant and further wherein the inventory includes the item for sale; and
modifying the inventory of the merchant via the computer system.
